(19) United States
(12) Patent Application Publication
(10) Pub. No.: US 2025/0222699 A1
(43) Pub. Date: Jul. 10, 2025

(54) PRINTING APPARATUS, METHOD OF CONTROLLING PRINTING APPARATUS, AND STORAGE MEDIUM

(71) Applicant: CANON KABUSHIKI KAISHA, Tokyo (JP)

(72) Inventor: KEIJI KURIYAMA, Saitama (JP)

(21) Appl. No.: 19/001,769

(22) Filed: Dec. 26, 2024

(30) Foreign Application Priority Data
Jan. 4, 2024 (JP) 2024-000198

(51) Int. Cl. B41J 2/21; B41J 2/045

(52) U.S. Cl. CPC B41J 2/2132; B41J 2/04508; B41J 2/04558; B41J 2/0456; B41J 2/0458; B41J 2/04581

(57) ABSTRACT

An embodiment of the present invention is a printing apparatus, including: a printing head ejecting a first ink from a nozzle to print a first adjustment pattern at a first ink dot number and print a second adjustment pattern at a second ink dot number; a storage unit storing reflection ratio data that is a reflection ratio for each ejection amount of the first ink ejected from the nozzle; a sensor reading an image printed on a printing medium; a first acquisition unit acquiring a reflection ratio based on a first reflection coefficient obtained by reading the first adjustment pattern by the sensor and a second reflection coefficient obtained by reading the second adjustment pattern by the sensor; and a second acquisition unit acquiring an ejection amount of the first ink in the nozzle based on the reflection ratio acquired by the first acquisition unit and the reflection ratio data.

### BACKGROUND

### Field

The present disclosure relates to a printing apparatus that prints an image by ejecting an ink from a nozzle of a printing head.

### Description of the Related Art

There has been known an ink jet printing apparatus that performs printing by ejecting an ink on a non-absorbent or low-absorbent printing medium and drying the ejected ink by using a fixation unit having heating and blowing functions. In such an apparatus, in some cases, an image is printed by using a transparent printing medium or a colored printing medium having a lower reflectance than that of a white printing medium. Additionally, in order to print an image with higher quality, it is necessary to adjust the printing head and the printing apparatus by using a printing medium that is actually used to print an image.

In Japanese Patent Laid-Open No. 2011-140207, it is possible to perform colorimetry of a white image by forming a black image on a white printing medium and then forming the white image thereon. Incidentally, since a light emission amount from a light emission unit in an optical sensor needs to be constant to detect a density by a colorimeter, in general, there has been adopted a method of obtaining the constant light emission amount by using a white calibration plate before the colorimetry.

### SUMMARY

However, in order to perform the colorimetry of the white image by using the white calibration plate, it is necessary to provide the white calibration plate and a part such as a shutter to protect the white calibration plate; for this reason, the cost increases. On the other hand, in a case where the colorimetry of the white image is performed without using the white calibration plate so as to prevent the cost increase, the colorimetry accuracy of the white image is reduced because of variation in the light emission amount from the light emission unit.

Under the circumstances, in light of the above-described problems, an object of the present disclosure is to implement calibration at high accuracy without using a calibration plate.

An embodiment of the present invention is a printing apparatus, including: a printing head configured to eject multiple inks including a first ink from nozzles, the printing head ejecting the first ink to print a first adjustment pattern at a first ink dot number and print a second adjustment pattern at a second ink dot number; a storage unit configured to store reflection ratio data that is a reflection ratio for each ejection amount of the first ink ejected from each of the nozzles; a sensor configured to read an image printed on a printing medium; a first acquisition unit configured to acquire a reflection ratio based on a first reflection coefficient obtained by reading the first adjustment pattern by the sensor and a second reflection coefficient obtained by reading the second adjustment pattern by the sensor; and a second acquisition unit configured to acquire an ejection amount of the first ink in the nozzle based on the reflection ratio acquired by the first acquisition unit and the reflection ratio data.

Further features of the present invention will become apparent from the following description of exemplary embodiments with reference to the attached drawings.

### BRIEF DESCRIPTION OF THE DRAWINGS

FIG. 1 is a perspective view of a printing apparatus;

FIG. 2 is a schematic side view of the printing apparatus;

FIG. 3 is a schematic view of a printing head;

FIGS. 4A and 4B are schematic views of an optical sensor;

FIG. 5 is a block diagram illustrating a configuration of a control system of the printing apparatus;

FIGS. 6A and 6B are diagrams describing multi-pass printing;

FIG. 7 is an explanatory view of a measurement pattern to measure a reflection coefficient with respect to each W ink amount on a K ink;

FIGS. 8A and 8B are data indicating correlation between each W ink amount on the K ink and the reflection coefficient;

FIG. 9 is a table holding a reflection ratio for each W ink ejection amount;

FIG. 10 is a flowchart of W ink ejection amount calculation processing according to a first embodiment;

FIG. 11 is a W ink ejection amount calculation pattern according to the first embodiment;

FIG. 12 is a W ink ejection amount calculation pattern according to a second embodiment;

FIG. 13 is a flowchart of W ink ejection amount calculation processing according to the second embodiment;

FIG. 14 is a K ink ejection amount calculation pattern according to a third embodiment;

FIG. 15 is a table holding a reflection ratio for each K ink ejection amount;

FIG. 16 is a flowchart of K ink ejection amount calculation processing according to the third embodiment;

FIG. 17 is a K ink ejection amount calculation pattern according to a fourth embodiment; and

FIG. 18 is a flowchart of K ink ejection amount calculation processing according to the fourth embodiment.

### DESCRIPTION OF THE EMBODIMENTS

Embodiments of the present disclosure are described below in detail with reference to the drawings. First, contents common among the later-described first to fourth embodiments are described.

### Common Embodiment

### (Configuration of Ink Jet Printing Apparatus)

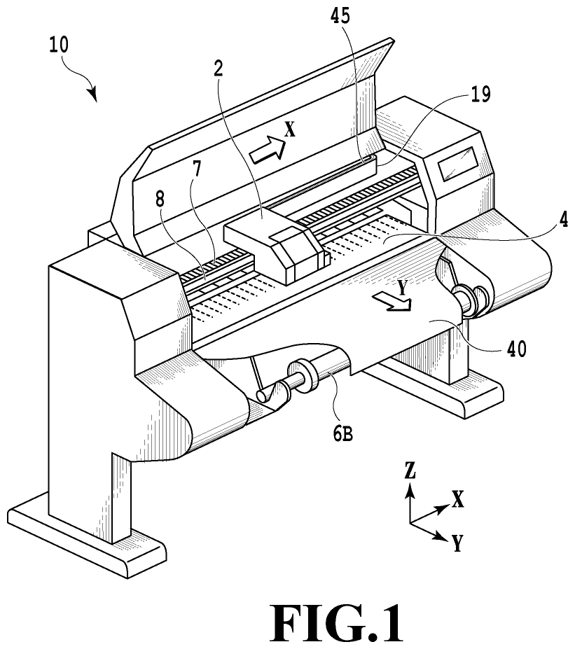

FIG. 1 is a perspective view illustrating appearance of an ink jet printing apparatus 10 (hereinafter, referred to as a printing apparatus 10) in the present embodiment. The printing apparatus 10 is a so-called serial scanning type printing apparatus that prints an image by scanning a printing head in an X direction (also referred to as a scanning direction and a main scanning direction) orthogonal to a Y direction (also referred to as a conveyance direction and a sub scanning direction) in which a printing medium 40 is conveyed in a printing position on a platen 4. Note that, a Z direction orthogonal to the X direction and the Y direction is a height direction, and this XYZ coordinate system is used commonly in the present disclosure.

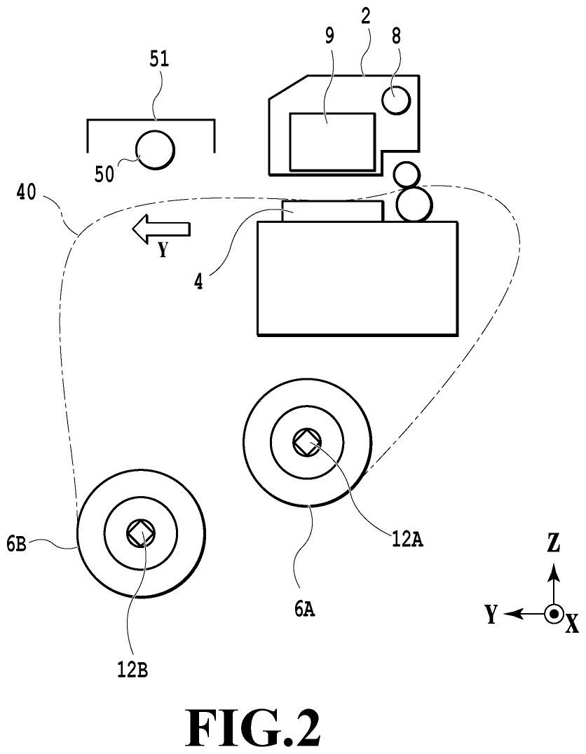

A configuration of the printing apparatus 10 and an overview of an operation during printing are described with reference to FIG. 1. First, the printing medium 40 held by a spooler 6A (see FIG. 2) and a spooler 6B is conveyed in the Y direction by a conveyance roller driven by a not-illustrated conveyance motor via a gear. On the other hand, a carriage unit 2 is reciprocally scanned (reciprocally moved) along a guide shaft 8 extending in the X direction by a not-illustrated carriage motor in a predetermined conveyance position. Then, in this scanning process, in a timing based on a position signal obtained by an encoder 7, an ejection operation to eject an ink from a nozzle of the printing head mountable on the carriage unit 2 is performed, and a constant band width corresponding to an array range of the nozzle is printed. In the present embodiment, a configuration in which the scanning is performed at a scanning velocity of 40 inches per second, and the ejection operation is performed at a printing resolution of 1200 dpi (at an interval of 1/1200 inches) is applied. Thereafter, in the configuration, the printing medium 40 is conveyed, and printing of the next band width is additionally performed. Note that, the printing head can perform the scanning at a velocity equal to or greater than 40 inches per second.

A tube 45 supplies the ink to the printing head from a not-illustrated ink tank. The tube 45 is protected by a tube guide 19 because the tube 45 is put into contact with a not-illustrated frame by the scanning of the carriage unit 2.

Note that, it is possible to use a carriage belt to transmit driving force from the carriage motor to the carriage unit 2. However, instead of the carriage belt, for example, it is also possible to use another driving method such as a device equipped with a leadscrew extending in the X direction and rotationally driven by the carriage motor and an engagement unit provided to the carriage unit 2 and engaged with a groove of the leadscrew.

The fed printing medium 40 is pinched and conveyed by a feed roller and a pinch roller and guided to the printing position on the platen 4. Here, the “printing position” indicates a position within a range of a region in which the printing head can perform the scanning and a position in which the printing head performs the printing. Additionally, a configuration in which image printing around this printing position is referred to as an “image printing unit”. Usually, in an idle state of the printing apparatus 10, a face surface of the printing head is capped; for this reason, the cap is opened before the printing to allow for the scanning of the printing head and the carriage unit 2. Thereafter, once data for one scanning is accumulated in a buffer, the carriage unit 2 is scanned by the carriage motor, and the printing is performed as described above.

FIG. 2 is a schematic side view of a printing apparatus main body. A heater 50 supported by a not-illustrated frame is arranged in a curing region positioned downstream in the Y direction of a position in which a printing head 9 mounted on the carriage unit 2 reciprocally scans in the X direction, and the ink in the form of liquid on the printing medium 40 is dried by heat. Hereinafter, a configuration that performs image fixation around the curing region is called an “image fixation unit”.

The heater 50 is covered with a heater cover 51, and the heater cover 51 has a function of efficiently emitting the heat of the heater 50 onto the printing medium 40 and a function of protecting the heater 50. After the printing by the printing head 9, the printing medium 40 is rolled up by the spooler 6A and the spooler 6B and forms a rolled-up medium in the form of a roll. Specifically, the heater 50 may include a sheathed heater, a halogen heater, and the like. A heating temperature of a heating unit in the above-described image fixation unit is set taking into consideration the film formability and the productivity of a water-soluble resin fine particle and the heat resistance of the printing medium 40. Note that, as the heating unit in the image fixation unit, heating by warm air blowing from above, heating by a contact-type heat conductive heater from below the printing medium 40, and the like may be used. Additionally, as for an installation position of the heating unit in the image fixation unit, although it is one place in the present embodiment, two or more places may be provided to be used together as long as a temperature measured by a radiation thermometer (not illustrated) on the printing medium 40 does not exceed the set value of the heating temperature.

In this case, the printing apparatus 10 of the present embodiment can perform so-called multi-pass printing in which an image is printed in a predetermined region (1/n band) on the printing medium 40 by the scanning of the printing head 9 multiple times (n times). The multi-pass printing is described later in detail.

### <Configuration of Printing Head>

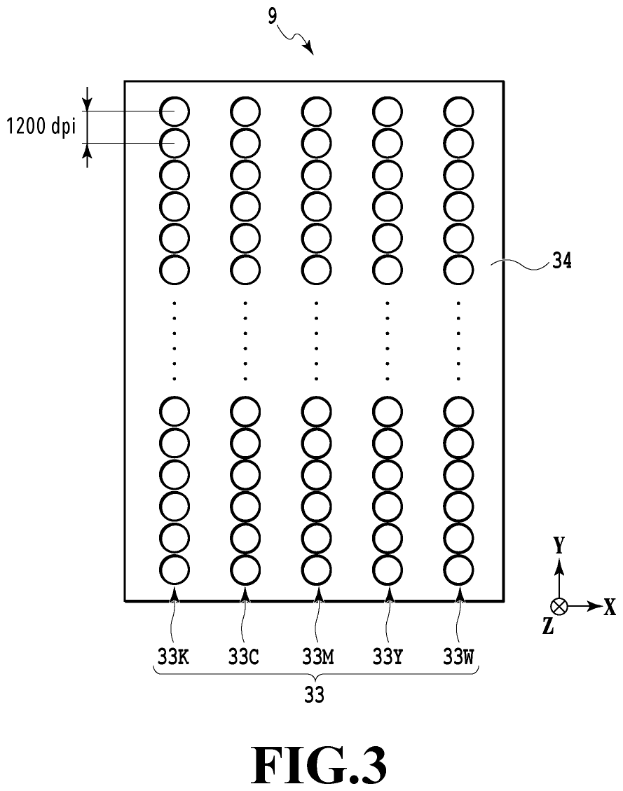

FIG. 3 illustrates a nozzle surface 34 of the printing head 9 in the present embodiment. The printing head 9 includes nozzle arrays that eject inks containing color materials. Specifically, the nozzle arrays are a nozzle array 33K that ejects a black ink, a nozzle array 33C that ejects a cyan ink, a nozzle array 33M that ejects a magenta ink, and a nozzle array 33Y that ejects a yellow ink, and a nozzle array 33W that ejects a white ink. Note that, in the present specification, the nozzle arrays are collectively called a nozzle array 33 in a case where it is not particularly necessary to distinguish by color. Additionally, this rule of collective terming is similarly applied to constituents other than the nozzle array.

In the printing head 9, these nozzle arrays are arranged next to each other in the order of the nozzle arrays 33K, 33C, 33M, 33Y, and 33W toward a +X direction (from a left side to a right side in FIG. 3). These nozzle arrays 33K, 33C, 33M, 33Y, and 33W are formed by arraying 1280 nozzles 30 that eject the corresponding inks in the Y direction (an array direction) at a density of 1200 dpi. The printing head 9 ejects the ink from the nozzle by using an ejection energy generation element such as an electrothermal transducer (a heater) and a piezo element. In a case where the electrothermal transducer is used, it is possible to cause the ink to bubble with the heating of the electrothermal transducer and to eject the ink from the nozzle by using the bubbling energy therefrom. Note that, although an ejection amount of the ink (referred to as an ink ejection amount) that is ejected from each nozzle 30 at one time in the present embodiment is about 4.5 pl at the factory, the amount may be changed over time.

These nozzle arrays 33K, 33C, 33M, 33Y, and 33W are each connected to a not-illustrated ink tank that stores the corresponding ink, and supplying of the ink is performed. Note that, the printing head 9 and the ink tank used in the present embodiment may be formed integrally or may be formed to be separable from each other.

### <Optical Sensor>

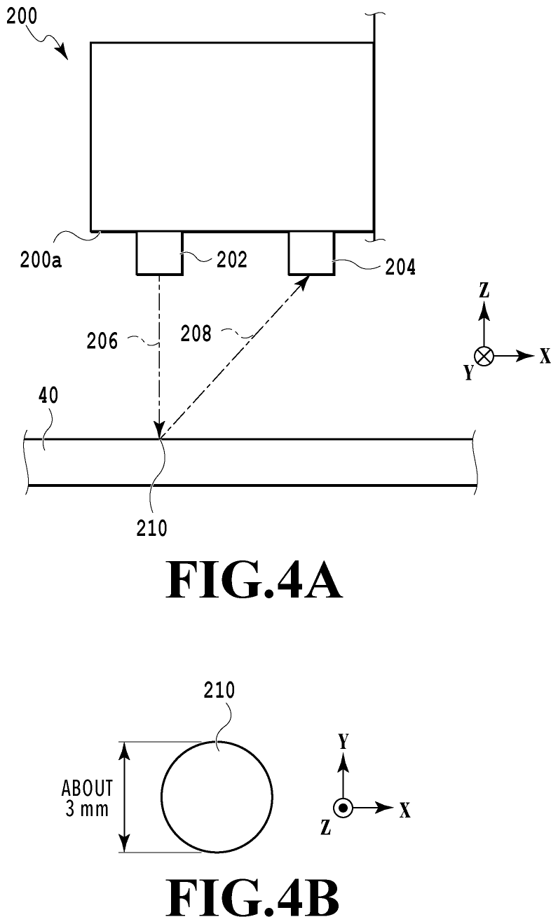

FIG. 4A is a schematic view illustrating a schematic configuration of an optical sensor, and FIG. 4B is a diagram illustrating a detection spot. An optical sensor 200 is provided and fixed to the carriage unit 2 such that a measurement region is positioned downstream in a +Y direction of the nozzle array 33 in the printing head 9. A lower surface 200a of the optical sensor 200 is positioned in a position coinciding with the nozzle surface 34 in the Z direction or in a position downstream in a +Z direction of the nozzle surface 34.

The optical sensor 200 includes a light emission unit 202 implemented by a visible LED of red, green, blue, and so on, and a light reception unit 204 implemented by a photodiode. The light emission unit 202 and the light reception unit 204 are provided on the lower surface 200a of the optical sensor 200. The light emission unit 202 emits light onto the printing medium 40, and the light reception unit 204 receives reflection light reflected from the printing medium 40. Accordingly, in the optical sensor 200, light 206 emitted from the light emission unit 202 diffuses reflection by the printing medium 40, and reflection light 208 therefrom is received by the light reception unit 204. A diameter of a detection spot 210 in which the light 206 emitted from the light emission unit 202 diffuses reflection by the printing medium 40 is about 3 mm in diameter, for example.

In the light reception unit 204, a detection signal (an analog signal) of the received reflection light 208 is transmitted to a control circuit on an electric substrate of the printing apparatus 10 via a flexible cable (not illustrated) and the like and is converted into a digital signal by an A/D converter in the control circuit. In the later-described detection of an optical characteristic of an adjustment pattern, the conveyance of the printing medium 40 along the Y direction and the movement of the carriage unit 2 to which the optical sensor 200 is attached along the X direction are executed alternately. With this, the optical sensor 200 synchronizes with the timing based on the position signal obtained by the encoder 7 and detects the density of the image printed on the printing medium 40 as an optical reflectance.

### <Configuration of Printing System>

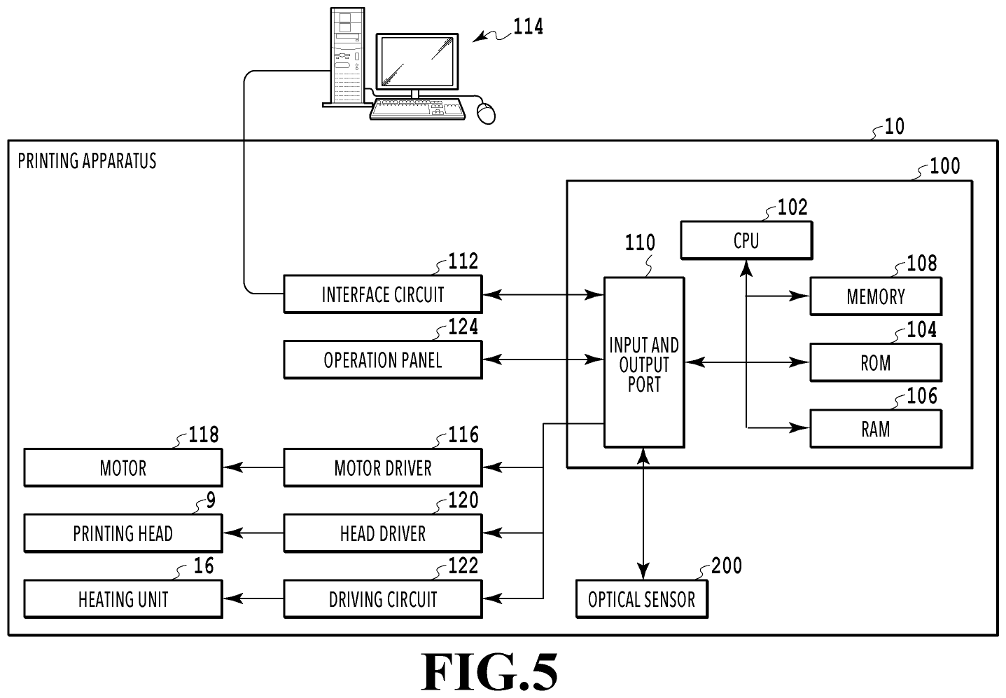

A configuration related to control of the printing apparatus 10 is described below with reference to FIG. 5. FIG. 5 is a block diagram illustrating a configuration of a control system of the printing apparatus 10.

A control unit 100 that controls overall the printing apparatus 10 includes a central processing unit (CPU) 102, a ROM 104, a RAM 106, and a memory 108. The CPU 102 performs operation control of each constituent in the printing apparatus 10, processing on inputted image data, and the like based on various programs. The ROM 104 functions as a memory that stores various controls, a processing program of the image data, and the like executed by the CPU 102. The RAM 106 stores various data used to control the printing apparatus 10. The memory 108 stores various data such as a mask pattern, the adjustment pattern, and the like described later. Additionally, the control unit 100 includes an input and output port 110 and is connected to various drivers, driving circuits, and the like via this input and output port 110.

The control unit 100 is connected to an interface circuit 112 via the input and output port 110 and is connected to a host apparatus 114 via this interface circuit 112. Additionally, the control unit 100 is connected to an operation panel 124 that can be operated by the user via the input and output port 110. The user inputs the image data into the printing apparatus 10 via the host apparatus 114 and inputs various types of information to the printing apparatus 10 via the host apparatus 114 and the operation panel 124. Additionally, the control unit 100 is connected to a motor driver 116 via the input and output port 110 and controls driving of a motor 118 via this motor driver 116. Note that, in FIG. 5, various motors in the printing apparatus 10 such as a motor to move the carriage unit 2 and a motor to drive a conveyance unit that conveys the printing medium 40 are collectively illustrated as the motor 118.

Moreover, the control unit 100 is connected with a head driver 120 via the input and output port 110 and ejects the ink by controlling the printing head 9 via the head driver 120. The control unit 100 is connected to a driving circuit 122 via the input and output port 110 and controls driving of a heating unit 16 via the driving circuit 122. In addition, the control unit 100 is connected to the optical sensor 200 via the input and output port 110 to control driving of the optical sensor 200 and detect the optical characteristic of the adjustment pattern based on an output from the optical sensor 200. Thus, in the present embodiment, the control unit 100 and the optical sensor 200 function as a detection unit that can detect the optical characteristic of the image printed on the printing medium 40.

In the control unit 100, the CPU 102 converts the image data inputted from the host apparatus 114 into printing data and stores the printing data in the RAM 106. Specifically, in a case where the CPU 102 obtains the image data expressed by information of 256 values (0-255) of 8-bit for each of RGB, the CPU 102 converts this image data into multivalued data expressed by multiple types of inks used for printing (in the present embodiment, K, C, M, Y, and W). With this color conversion processing, multivalued data expressed by the information of 256 values (0-255) of 8-bit defining the tonality of each of the K, C, M, Y, and W inks in each pixel group formed of multiple pixels is generated.

Next, quantization of the multivalued data expressed by K, C, M, Y, and W is executed, and quantization data (binary data) expressed by information of two values (0, 1) of 1-bit defining ejection or non-ejection of each of the K, C, M, Y, and W inks to each pixel is generated. As processing of this quantization, it is possible to use various publicly-known quantization methods such as an error diffusion method, a dither method, and an index method. Thereafter, distribution processing to distribute the quantization data to the scanning performed multiple times on a unit region of the printing head 9 is performed. With this distribution processing, the printing data expressed by the information of two values (0, 1) of 1-bit defining the ejection or non-ejection of each of the K, C, M, Y, and W inks to each pixel in corresponding one of the scanning performed multiple times on the unit region of the printing medium 40 is generated. This distribution processing corresponds to the scanning performed multiple times and is executed by using the mask pattern defining acceptance or non-acceptance of the ejection of the ink to each pixel. Note that, the generation of the printing data as described above is not limited to be executed by the control unit 100 and may be executed by the host apparatus 114. Additionally, a part of the processing may be performed by the host apparatus 114, and the rest of the processing may be executed by the control unit 100.

### <Multi-Pass Printing Method>

In the present embodiment, an image is printed by so-called multi-pass printing in which printing is performed by the scanning performed multiple times on a predetermined region on the printing medium 40 by using each of the K, C, M, Y, and W inks.

First, the multi-pass printing using the entire nozzle array region is described below using a white ink and a black ink as an example. Note that, in the present specification, the white ink is referred to as a W ink, and the black ink is referred to as a K ink.

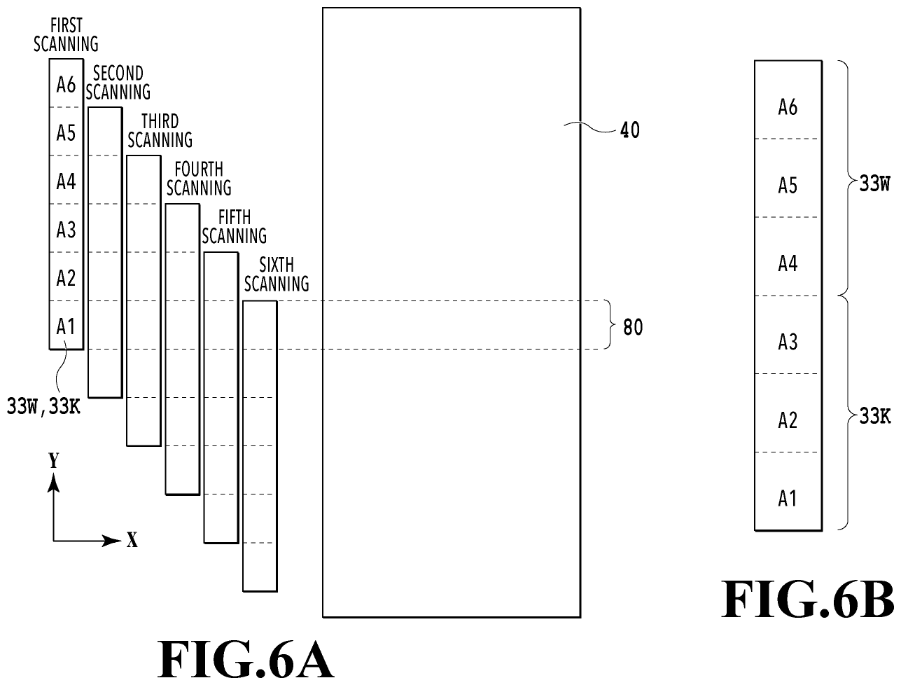

FIG. 6A is a diagram describing a multi-pass printing method by using the entire nozzle array region of the Wink and the K ink. In this case, the Wink and the K ink are ejected in each of six times of the scanning on a predetermined region from each of six nozzle groups A1 to A6 formed by dividing the nozzle arrays 33W and 33K in the Y direction. The printing data of the W ink and the K ink are allocated to each scanning such that the printing of the image is completed by six times of the scanning, respectively. Note that, although the printing medium 40 is conveyed downstream in the Y direction after one time of the scanning of the printing head 9 ends in reality, for the sake of simplification, FIG. 6A illustrates that the printing head 9 is moved upstream in the Y direction after one time of the scanning.

First, in the first scanning, the printing head 9 is scanned under a positional relationship in which a predetermined region 80 on the printing medium 40 faces the nozzle group A1 of the nozzle arrays 33W and 33K. In this process, according to the printing data of each of the W ink and the K ink corresponding to the first scanning, the W ink and the K ink are ejected from the nozzle group A1 to the predetermined region 80. After the first scanning ends, the printing medium is conveyed in the Y direction by a distance corresponding to one nozzle group. Thereafter, the second scanning is performed, and the W ink and the K ink are ejected from the nozzle group A2 to the predetermined region 80. Thereafter, the conveyance of the printing medium and the ejection from the printing head 9 are performed alternately, and the ejection from the nozzle groups A3 to A6 in the third to the sixth scanning on the predetermined region 80 is executed. Thus, the multi-pass printing on the predetermined region 80 is completed.

Subsequently, a multi-pass printing method in which different regions of the nozzle array are used depending on the color of the ink is described. FIG. 6B is a diagram illustrating that the K ink is ejected by the nozzle groups A1 to A3 while the W ink is ejected by the nozzle groups A4 to A6 out of the nozzle groups A1 to A6 illustrated in FIG. 6A. In this case, the printing data of the K ink is allocated such that the printing of the image is completed by the first to the third scanning, and the printing data of the W ink is allocated such that the printing of the image is completed by the fourth to the sixth scanning.

First, in the first scanning, the printing head 9 is scanned under a positional relationship in which the predetermined region 80 on the printing medium 40 faces the nozzle group A1 of the nozzle array 33K. In this process, according to the printing data of the K ink corresponding to the first scanning, the K ink is ejected from the nozzle group A1 to the predetermined region 80. After this first scanning ends, the printing medium is conveyed in the Y direction by a distance corresponding to one nozzle group. Thereafter, the ejection from the printing head 9 and the conveyance of the printing medium are performed alternately, the second to the third scanning is performed, and the K ink is ejected from the nozzle groups A2 to A3 to the predetermined region 80 to complete the image of the K ink in the printing in the third scanning. Subsequently, according to the printing data of the W ink corresponding to the fourth scanning, the W ink is ejected from the nozzle group A4 to the predetermined region 80. Thereafter, the conveyance of the printing medium and the ejection from the printing head 9 are performed alternately, and the ejection of the W ink from the nozzle groups A4 to A6 in the fourth to the sixth scanning on the predetermined region 80 is executed. Thus, the multi-pass printing on the predetermined region 80 is completed.

Thus, with the nozzle array groups to be used being divided for the W ink and the K ink, it is possible to print the image such that the image of the K ink is completed in the first three times of scanning out of the six times of the scanning on the predetermined region and the image of the Wink is completed in the later three times of scanning. With this, in a predetermined printing region, it is possible to perform printing in which the image of the Wink is overlapped with the image printed with the K ink while printing the K ink as a background at the same printing scanning.

### <Ink>

The K, C, M, Y, and W inks used in the present embodiment are described. These inks include a solid content printing an image and a volatile liquid component. The solid content may include a color material such as a pigment and a dye, and the liquid component may include water and water-soluble organic solvent. Any of the inks contain the water-soluble resin fine particle that closely attaches the printing medium and the color material to each other and improves the scratch resistance (the fixity) of the printing image.

The white (W) ink of the present embodiment contains a white color material as the color material, and it is possible to preferably use a titanium oxide particle as the white color material. There are titanium oxides of rutile type, anatase type, and brookite type depending on a crystal structure thereof, and the rutile type with low photocatalytic activity is preferable. A method of manufacturing the titanium oxide may include a sulfuric acid method, a chlorine method, and the like. A contained amount (% by mass) of the titanium oxide particle in the ink is preferably 5% by mass or greater and 20% by mass or smaller based on the total mass of the ink in terms of the ink stability.

A zeta potential of the titanium oxide particle in pure water is preferably 0 mV or greater. The zeta potential is an indicator of a charged state of a surface of the titanium oxide particle, which can be measured by electrophoretic light scattering. In a case where an amount of negative charge is greater than an amount of positive charge on the surface of the titanium oxide particle, it is easily absorbed to resin having an anionic substrate, and the dispersion stability of the titanium oxide is improved. Additionally, in order to prevent a lack of charge repulsion between the titanium oxide particles due to excessive consumption of the anionic substrate of the resin, the zeta potential is preferably 40 mV or smaller.

As the white color material in the white ink, it is also possible to use a resin particle having a hollow structure together in addition to the titanium oxide particle. The resin particle having the hollow structure may include the following. For example, a resin particle including a unit derived from styrene and acryl such as MH5055 (manufactured by Zeon Corporation), ROPAQUE OP-62, OP-84J, OP-91, HP-1055, HP-91, ULTRA (manufactured by Rohm and Haas Company). Additionally, it may be a resin particle and the like including a unit derived from cross-linking type styrene and acryl such as SX-863 (A), 864 (B), 866 (A), 866 (B), 868 (manufactured by JSR), ROPAQUE ULTRA E, ULTRA DUAL (manufactured by Rohm and Haas Company).

Note that, although the W ink contains the above-described white color material as a main component, it is also possible to contain another color material without impairing the whiteness to adjust the slight white color appearance visually recognized by the reflection light and the like.

### <Printing Medium>

The printing apparatus in the present embodiment performs printing on a low permeability printing medium into which water permeates poorly. The low permeability printing medium herein is, as described above, a medium having completely no water absorbency or the absorbed amount is considerably low. Accordingly, with a water-based ink containing no organic solvent, the ink is repelled, and it is impossible to form an image on the medium. On the other hand, the low permeability printing medium has excellent water resistance and weather resistance and is appropriate for a medium to form a printing product to be used outdoors. Usually, a printing medium with a water contact angle at 25° C. is 45° or greater or preferably 60° or greater is used.

The low permeability printing medium may include a printing medium in which a plastic layer is formed on the uppermost surface of a base material, a printing medium in which no ink reception layer is formed on the base material, a sheet, a film, a banner, or the like that is made of glass, yupo, plastic, or the like. An example of the above-described plastic may include polyvinyl chloride, polyethylene terephthalate, polycarbonate, polystyrene, polyurethane, polyethylene, polypropylene, and the like. The low permeability printing medium has excellent water resistance, light resistance, and scratch resistance; for this reason, in general, the low permeability printing medium is used to print a printing product for outdoor display.

As an example of a method of evaluating the permeability of the printing medium, it is possible to use the Bristow's method described in “Method for Determining the Liquid Absorbability of Paper and Board” of JAPAN TAPPI standards No. 51. In the Bristow method, a predetermined amount of ink is poured into a holding container having an opening slit of a predetermined size, and through the slit, the ink is put in contact with the printing medium that is processed into the form of a strip and wound around a disk. Then, while keeping the position of the holding container, the disk is rotated, and an area (a length) of an ink region that is transferred to the printing medium is measured. Based on the area of this ink region, it is possible to calculate a transfer amount (ml·m−2) per second for unit area. In the present embodiment, a printing medium that obtains the transfer amount (a water absorbed amount) of the ink by 30 msec1/2 by the above-described Bristow method that is smaller than 10 ml·m−2 is recognized as the low permeability printing medium.

### First Embodiment

In the present embodiment, a method of calculating an ejection amount of the W ink is described. It is impossible to measure a density difference between patches of the W ink printed on the white printing medium since the ink and the printing medium are in the same color. Additionally, it is also impossible to measure a density difference between patches of the W ink printed on a transparent printing medium because there is an effect of the platen 4. In the claims of this application, “calculating” is expressed as “acquiring”.

In the present embodiment, first, an image as a background (a background image) is printed on the printing medium 40 with the K ink, and after the image of the K ink is fixed sufficiently, the adjustment pattern is printed on the background with the W ink. With this, it is possible to measure a density difference based on a difference in an exposure amount of the K ink in the background according to the Wink amount, and it is possible to perform color calibration of the nozzle of the W ink in the printing head 9. Note that, although it is preferable to use the K ink with a high absorption characteristic of the light as the ink to print the background, it is not limited thereto, and it is possible to adopt an ink containing another colored color material (for example, a C ink) as long as it is possible to measure a desired density difference.

Here, density calculation of the W ink is described. The absorption of the light of the colored ink is increased by increasing an ink shot amount on the printing medium 40. Therefore, it is possible to define as follows a density value in a case where the shot amount of the colored ink is X %, where a reflection coefficient of the patch that is outputted by a sensor is P(X), and a reflection coefficient of a white calibration plate that is outputted by the sensor is P (0).

$$D ( X ) = - log ( P ( X ) / P ( 0 ) ) \qquad Expression ( 1 )$$

On the other hand, unlike the colored ink, a reflection light amount of the W ink is increased by increasing the ink shot amount on the printing medium 40. Therefore, it is possible to define as follows a density value in a case where the shot amount of the W ink is X %, where the reflection coefficient of the patch is P(X), the reflection coefficient of the white calibration plate is P (0), and a reflection coefficient of only the ink (for example, the K ink) printing the background is P (1).

$$D ( X ) = - log ( P ( 0 ) - P ( X ) / P ( 0 ) - P ( 1 ) ) \qquad Expression ( 2 )$$

In a case where the density is measured by using the Expression (1) and the Expression (2), it is important to obtain the correct reflection coefficient P(0) of the white calibration plate. However, conventionally, no white calibration plate has been mounted in the printing apparatus to reduce the manufacturing cost, in some cases. In this case, in the density measurement of the colored ink, the density may be measured based on a mutual relationship with paper white obtained by using the reflection coefficient of the patch in a paper white region instead of the white calibration plate. On the other hand, in the density measurement of the W ink, there is a problem of instability in the measurement accuracy of the white density since the reflection coefficient of the printing medium 40 is varied.

In light of the above-described circumstances, in the present embodiment, a method of calculating the W ink ejection amount based on the reflection coefficients of two patches of different shot amounts without performing the white density measurement is proposed.

First, a method of obtaining information that needs to be stored in the printing apparatus 10 main body in advance is described.

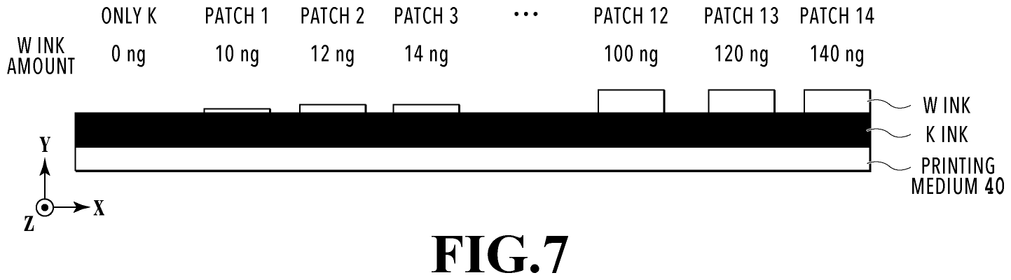

FIG. 7 is an explanatory view of the measurement pattern to measure the reflection coefficient with respect to each W ink amount on the K ink. As illustrated in FIG. 7, in a case where the K ink is printed on the printing medium 40, it is desirable to use a great amount of the K ink on the paper surface, and specifically, the shot amount that allows the reflection coefficient to be 1% or smaller is desirable. On the fixed K ink, the patches of different amounts of the W ink are printed by using the printing head 9 holding the Wink ejection amount. In the present embodiment, multiple patches of different W ink amounts at 600 dpi are printed. Note that, since it is desirable to obtain a great number of data, it is desirable to print many patches of different W ink amounts. After the patches are printed, the reflection coefficients of the patches of different W ink amounts that are printed on the K ink are each measured by using the optical sensor 200.

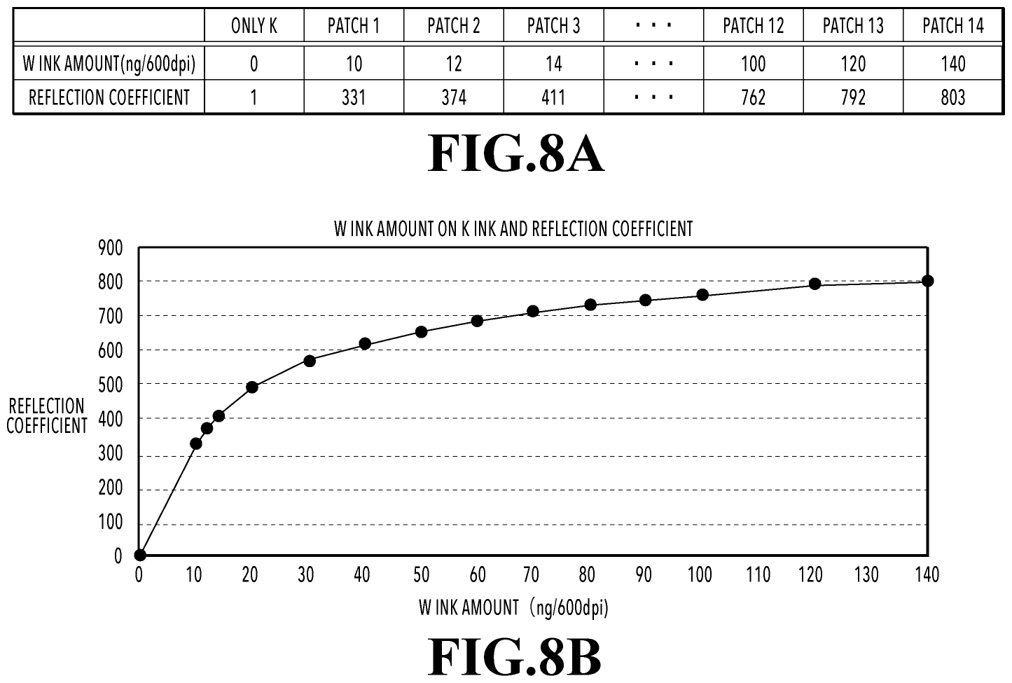

FIGS. 8A and 8B illustrate correlation between the W ink amount on the K ink and the reflection coefficient. Specifically, FIG. 8A illustrates a measurement result of the reflection coefficient with respect to each W ink amount on the K ink. In the present embodiment, since the patches are printed on the K image to obtain the reflection coefficients with respect to the W ink amounts on the K ink, the reflection coefficients with respect to the W ink amounts are the same among various printing media.

FIG. 8B is a graph illustrating a relationship between each W ink amount on the K ink and the reflection coefficient, in which a horizontal axis is the W ink amount while a vertical axis is the reflection coefficient. Until the W ink amount reaches around 40 ng, the W ink does not cover the entire surface of the K ink yet; for this reason, an amplification amount of the reflection coefficient along with amplification of the W ink amount is great. On the other hand, once the Wink amount reaches 40 ng or greater, the W ink covers the entire surface of the K ink; for this reason, the amplification amount of the reflection coefficient along with the amplification of the W ink amount is small. Thus, the amplification amount of the reflection coefficient is changed according to the W ink amount.

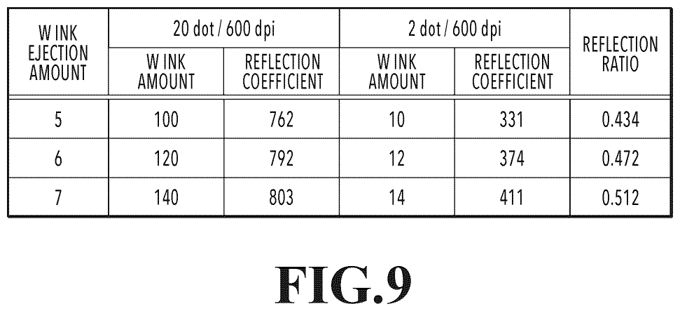

FIG. 9 illustrates a reflection ratio between a first W ink dot number and a second W ink dot number on the K ink for each W ink ejection amount. In FIG. 9, the W ink amount and the reflection coefficient in a case where 20 dots are printed at 600 dpi as the first W ink dot number, and 2 dots are printed at 600 dpi as the second W ink dot number are illustrated.

Since the first W ink dot number is 20 dots, in a case where the W ink ejection amount is 5 ng, the W ink amount is 100 ng, and the reflection coefficient is 762. Likewise, in a case where the W ink is 6 ng, the reflection coefficient is 792, and in a case where the W ink ejection amount is 7 ng, the reflection coefficient is 803.

Since the second W ink dot number is 2 dots, in a case where the W ink ejection amount is 5 ng, the W ink amount is 10 ng, and the reflection coefficient is 331. Likewise, in a case where the W ink ejection amount is 6 ng, the reflection coefficient is 374, and in a case where the W ink ejection amount is 7 ng, the reflection coefficient is 411.

Next, the reflection ratio between the first W ink dot number and the second W ink dot number on the K ink is calculated. In a case where the W ink ejection amount is 5 ng, the reflection ratio between the first W ink dot number and the second W ink dot number on the K ink is 331/762=0.434. Likewise, in a case where the W ink ejection amount is 6 ng, the reflection ratio is 0.472, and in a case where the Wink ejection amount is 7 ng, the reflection ratio is 0.512.

Thus, it can be seen that the reflection ratio between the first W ink dot number and the second W ink dot number on the K ink is changed for each Wink ejection amount. This is because the amplification amount of the reflection coefficient with respect to the amplification amount of the W ink ejection amount is changed by changing the W ink dot number on the K ink.

Details of the method of calculating the W ink ejection amount according to the present embodiment, that is, the method of calculating the Wink ejection amount by using the fact that the reflection ratio is changed for each W ink ejection amount are described below.

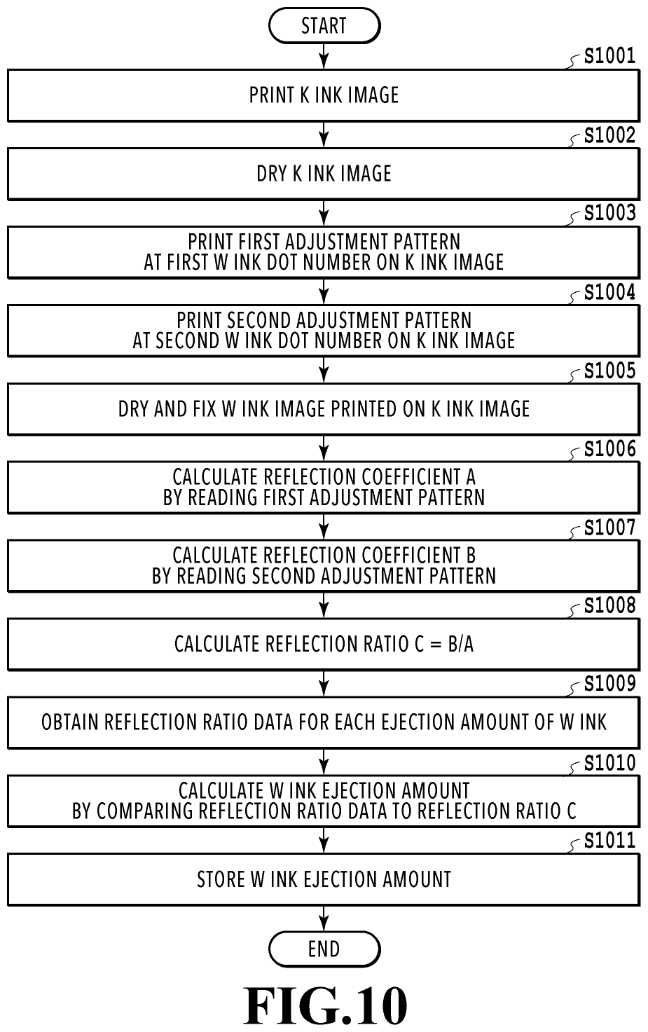

FIG. 10 is a flowchart of W ink ejection amount calculation processing according to the present embodiment. A series of processing illustrated in the flowchart in FIG. 10 is performed with the CPU 102 deploying a program code stored in the ROM 104 to the RAM 106 to execute. Alternatively, a part of or all the series of processing illustrated in FIG. 10 may be executed by hardware such as another ASIC or an electric circuit. Note that, in each processing in the flowchart described below, a sign S means that it is a step in the flowchart.

In a case where a user who wants to adjust a white density operates the printing apparatus 10 or the host apparatus 114, the W ink ejection amount calculation processing illustrated in FIG. 10 is started.

In S1001, the CPU 102 executes the printing processing to print the K ink image on the printing medium 40.

In S1002, the CPU 102 executes drying processing to dry the K ink image printed in S1001. Note that, as the drying in the present step, natural drying, heat fixation, UV curing with a UV ink, or the like may be used.

In S1003, the CPU 102 executes the printing processing to print a first adjustment pattern by using the W ink at the first W ink dot number on the K ink image printed in S1001.

In S1004, the CPU 102 executes the printing processing to print a second adjustment pattern by using the Wink at the second Wink dot number on the K ink image printed in S1001. Note that, in the present embodiment, a value of the second Wink dot number is set smaller than a value of the first W ink dot number to make a reflection coefficient A greater than a reflection coefficient B (details are described later).

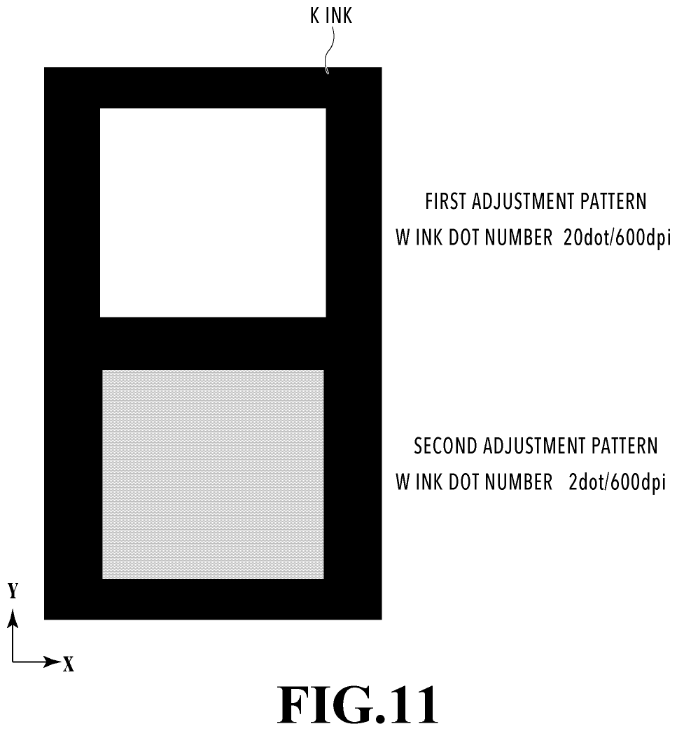

Here, FIG. 11 illustrates an example of a Wink ejection amount calculation pattern printed in the present embodiment. This ink ejection amount reference pattern is formed of the first adjustment pattern printed in S1003 and the second adjustment pattern printed in S1004. As illustrated in FIG. 11, the two patterns, which are specifically the first adjustment pattern and the second adjustment pattern, are printed next to each other in the Y direction (the conveyance direction). Note that, in FIG. 11, the first W ink dot number in a case of printing the first adjustment pattern is 20 dots at 600 dpi, and the second W ink dot number in a case of printing the second adjustment pattern is 2 dots at 600 dpi.

In S1005, the CPU 102 dries and fixes the W ink image printed on the K ink image in S1003 and S1004. Note that, since a surface shape of the image affects the reflection coefficient, it is desirable that the heat fixation is adopted as a fixation method in the present step, and the density of the W ink image is stable.

In S1006, the CPU 102 reads the first adjustment pattern by using the optical sensor 200, and the reflection coefficient A is calculated based on a result of the reading.

In S1007, the CPU 102 reads the second adjustment pattern by using the optical sensor 200 and calculates the reflection coefficient B based on a result of the reading. Note that, light amount adjustment is executed by using the first adjustment pattern before S1006 such that the reflection light of the first adjustment pattern and the reflection light of the second adjustment are within a light reception range of the optical sensor 200. With this, it is possible to read any adjustment patterns.

In S1008, the CPU 102 calculates a reflection ratio C(=B/A) based on the reflection coefficient A calculated in S1006 and the reflection coefficient B calculated in S1007 (that is, the reflection coefficient B is divided by reflection coefficient A).

In S1009, the CPU 102 obtains reflection ratio data for each ejection amount of the Wink. The reflection ratio data obtained in the present step is, specifically, a table holding the reflection ratio for each ejection amount of the W ink as illustrated in FIG. 9, and this table is stored in the ROM 104 or the memory 108 in advance.

In S1010, the CPU 102 calculates the W ink ejection amount by comparing the reflection ratio data for each ejection amount of the W ink obtained in S1009 to the reflection ratio C calculated in S1008. Specifically, in a case where any one of multiple values of the reflection ratios held in the table matches the reflection ratio C, the W ink ejection amount corresponding to the matching value is selected. On the other hand, if no value matches, the W ink ejection amount corresponding to a value that is the closest to the reflection ratio C is selected from the values of the reflection ratios held in the table, or the W ink ejection amount is calculated by interpolation calculation. Here, as an example, Wink ejection amount calculation in a case where the reflection ratio C is 0.453 is described. This value, 0.453, is an intermediate value between the reflection ratio of 0.434 in a case where the W ink ejection amount is 5 ng and the reflection ratio of 0.472 in a case where the Wink ejection amount is 6 ng in the relationship between the values of the reflection ratios for the ejection amounts of the W ink illustrated in FIG. 9. Accordingly, in this case, 5.5 ng that is an intermediate value between 5 ng and 6 ng is calculated for the W ink ejection amount.

Finally, in S1011, the CPU 102 stores the W ink ejection amount calculated in S1010 in a storage region (the ROM 104 or the memory 108), and the series of processing ends. Note that, although the W ink ejection amount calculation by the interpolation calculation using three grades of the W ink ejection amounts (see FIG. 9) is described in the above-described embodiment, it is not limited to the three grades, and it is desirable to store more reflection ratios corresponding to the W ink ejection amounts (that is, four or more grades) in advance.

As described above, in the present embodiment, it is possible to calculate the highly accurate W ink ejection amount by storing the reflection ratio between the first W ink dot number and the second W ink dot number for each W ink ejection amount in advance and comparing the stored reflection ratio to the measured reflection ratio. With this, it is possible to implement the colorimetry of the white image and the white calibration at high accuracy without using the white calibration plate.

### Second Embodiment

In the first embodiment, the W ink ejection amount calculation using the two patches is described; however, in a case where the optical sensor has a reading error, an error also occurs in the ejection amount calculation. In order to reduce such an error, in the present embodiment, a method of calculating the W ink ejection amount by using multiple patches is described. Note that, hereinafter, descriptions of contents similar to the above-described descriptions are omitted as needed.

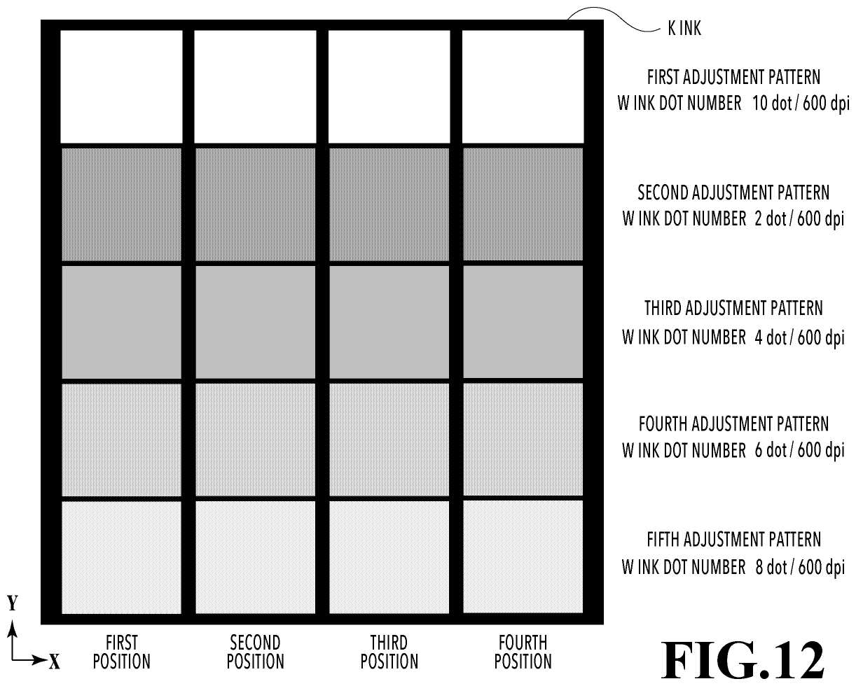

FIG. 12 illustrates a W ink ejection amount calculation pattern according to the present embodiment. As illustrated in FIG. 12, the same adjustment patterns are printed in four places in different positions in the X direction (the main scanning direction). Additionally, five patterns of different ejection amounts of the W ink are printed next to each other in the Y direction (the conveyance direction, the sub scanning direction). Note that, although it is described using the four patterns arrayed in the X direction and the five patterns arrayed in the Y direction in the present embodiment, it is not limited thereto, and the pattern number in the X direction and the pattern number in the Y direction may be increased and decreased.

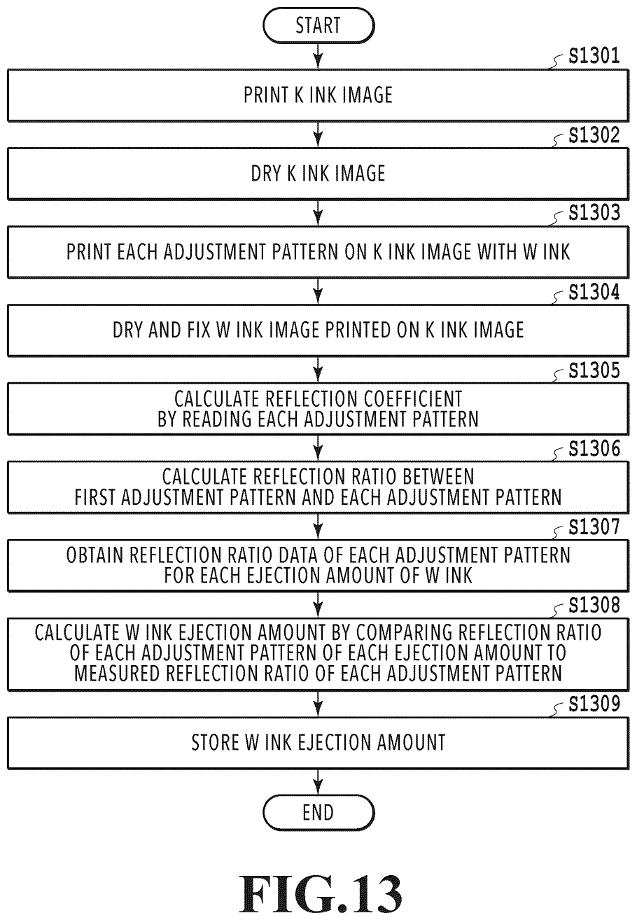

FIG. 13 is a flowchart of W ink ejection amount calculation processing according to the present embodiment. A series of processing illustrated in the flowchart in FIG. 13 is performed with the CPU 102 deploying a program code stored in the ROM 104 to the RAM 106 to execute. Alternatively, a part of or all the series of processing illustrated in FIG. 13 may be executed by hardware such as another ASIC or an electric circuit.

As with the first embodiment, in a case where the user who wants to adjust the white density operates the printing apparatus 10 or the host apparatus 114, the W ink ejection amount calculation processing illustrated in FIG. 13 is started.

S1301 and S1302 are similar to the first embodiment (see S1001 and S1002 in FIG. 10).

In S1303, the CPU 102 executes the printing processing to print adjustment patterns from a first adjustment pattern to an n-th adjustment pattern (printed at an n-th dot number) on the K ink image printed in S1301 (n is an integer greater than 2). In the printing processing in the present step, multiple combinations of the first adjustment pattern to the n-th adjustment pattern are printed. To be specific, in the example in FIG. 12, each of the first adjustment pattern to a fifth adjustment pattern is arranged in different positions in the conveyance direction of the printing medium (the Y direction). Additionally, four combinations of the first adjustment pattern to the fifth adjustment pattern are printed. Each of these combinations is arranged in different positions in the main scanning direction of the printing head (the X direction).

In S1304, the CPU 102 dries and fixes the W ink image printed on the K ink image in S1303.

In S1305, the CPU 102 reads each adjustment pattern of the first to the n-th adjustment patterns by using the optical sensor 200, and based on a result of the reading, the reflection coefficient corresponding to each adjustment pattern is calculated. Note that, in the example in FIG. 12, each adjustment pattern of the first to the fifth adjustment patterns is read.

In S1306, the CPU 102 calculates the reflection ratio between the first adjustment pattern and each of the other adjustment patterns. Note that, in the example in FIG. 12, four reflection ratios are calculated in the present step.

Here, calculation of the reflection ratio according to the present embodiment, that is, the reflection ratio between the first adjustment pattern and each of the second to the fifth adjustment patterns is described. First, the reflection coefficients of the first to fifth adjustment patterns in the same position in the X direction (the position in the X direction in this case is a first position) are obtained, and based on the obtained reflection coefficients, the reflection ratios between the first adjustment pattern and each of the second to the fifth adjustment patterns is calculated. Likewise, in each of a second position to a fourth position different from the first position, the reflection ratio between the first adjustment pattern and each of the second to the fifth adjustment patterns is calculated. Next, an average value of the reflection ratios between the first adjustment pattern and the second adjustment pattern in the respective first to fourth positions (that is, an average value of four reflection ratios) is calculated, and the calculated average value is treated as the reflection ratio between the first adjustment pattern and the second adjustment pattern.

As with the reflection ratio between the first adjustment pattern and the second adjustment pattern, the reflection ratio between the first adjustment pattern and the third adjustment pattern, the reflection ratio between the first adjustment pattern and the fourth adjustment pattern, and the reflection ratio between the first adjustment pattern and the fifth adjustment pattern are calculated. Thus, with the reflection ratio being calculated as the average value, even in a case where the optical sensor has the reading error between different positions in the X direction, it is possible to reduce an effect of the error. Note that, although the average value of the four reflection ratios is calculated in the present embodiment, it is not limited thereto, and an average value of two middle reflection ratios, except the top and the bottom reflection ratios, may be calculated.

In S1307, the CPU 102 obtains the reflection ratio data of each adjustment pattern for each ejection amount of the W ink.

In S1308, the CPU 102 calculates the W ink ejection amount by comparing the reflection ratio data of each adjustment pattern for each ejection amount of the W ink that is obtained in S1307 to the reflection ratio with respect to each adjustment pattern calculated in S1306. In the example in FIG. 12, since there is the reflection ratio between the first adjustment pattern and each of the second to the fifth adjustment patterns, the ejection amount is calculated for each combination of the first adjustment pattern and each of the second to the fifth adjustment patterns, and as a result, the four ejection amounts are calculated. The average value of these four ejection amounts is calculated as the W ink ejection amount. Note that, although the average value of the four values is used in this case, it is not limited thereto, and an average value of two middle values, except the top and the bottom values, may be used.

Finally, in S1309, the CPU 102 stores the W ink ejection amount calculated in S1308 in the ROM 104, and the series of processing ends.

As described above, in the present embodiment, the multiple patterns are arranged in each of the X direction and the Y direction. With this, it is possible to calculate the W ink ejection amount while reducing an effect of the reading error of the optical sensor.

### Third Embodiment

In the first embodiment and the second embodiment, the W ink ejection amount is calculated; however, in the present embodiment, an ejection amount of the colored ink is calculated.

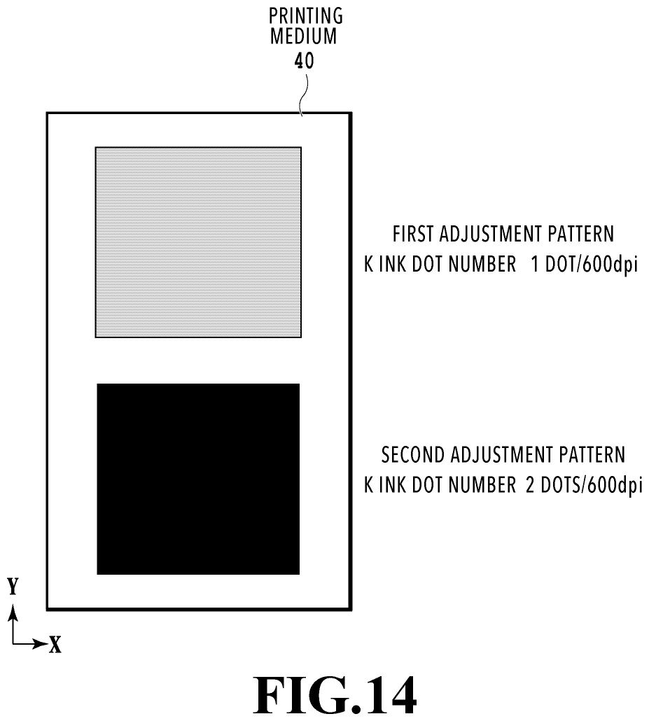

FIG. 14 is a diagram illustrating a K ink ejection amount calculation pattern according to the present embodiment. As illustrated in FIG. 14, two patterns, which are specifically a first adjustment pattern and a second adjustment pattern, are printed next to each other in the Y direction (the conveyance direction). Note that, although the printing is performed by using the K ink in the present embodiment, it is not limited thereto, and another colored ink such as the C ink, an Mink, or a Y ink may be used for the printing.

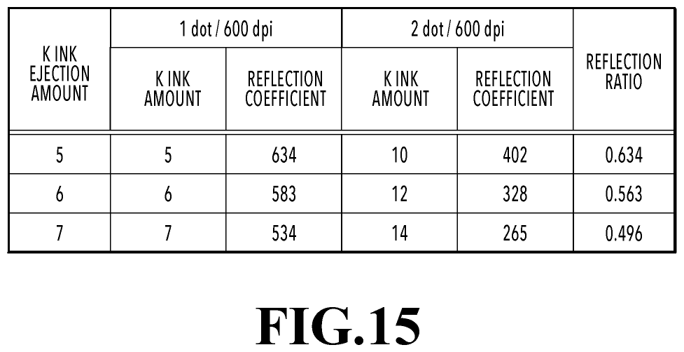

FIG. 15 illustrates a reflection ratio between a first K ink dot number and a second K ink dot number for each K ink ejection amount. In FIG. 15, the K ink amount and the reflection coefficient in a case where the printing is performed with the first K ink dot number of 1 dot at 600 dpi and the second K ink dot number of 2 dots at 600 dpi are illustrated.

Since the first K ink dot number is 1 dot, in a case where the K ink ejection amount is 5 ng, the K ink amount is 5 ng, and the reflection coefficient is 634. Likewise, in a case where the K ink ejection amount is 6 ng, the reflection coefficient is 583, and in a case where the K ink ejection amount is 7 ng, the reflection coefficient is 534.

Since the second K ink dot number is 2 dots, in a case where the K ink ejection amount is 5 ng, the K ink amount is 10 ng, and the reflection coefficient is 402. Likewise, in a case where the K ink ejection amount is 6 ng, the reflection coefficient is 328, and in a case where the K ink ejection amount is 7 ng, the reflection coefficient is 265.

Next, the reflection ratio between the first K ink dot number and the second K ink dot number is calculated. In a case where the K ink ejection amount is 5 ng, the reflection ratio between the first K ink dot number and the second K ink dot number is 402/634=0.634. Likewise, in a case where the K ink ejection amount is 6 ng, the reflection ratio is 0.563, and in a case where the K ink ejection amount is 7 ng, the reflection ratio is 0.496.

Thus, as with the W ink described in the first embodiment, the reflection ratio is changed for each K ink ejection amount also in a case of the K ink, which is the colored ink.

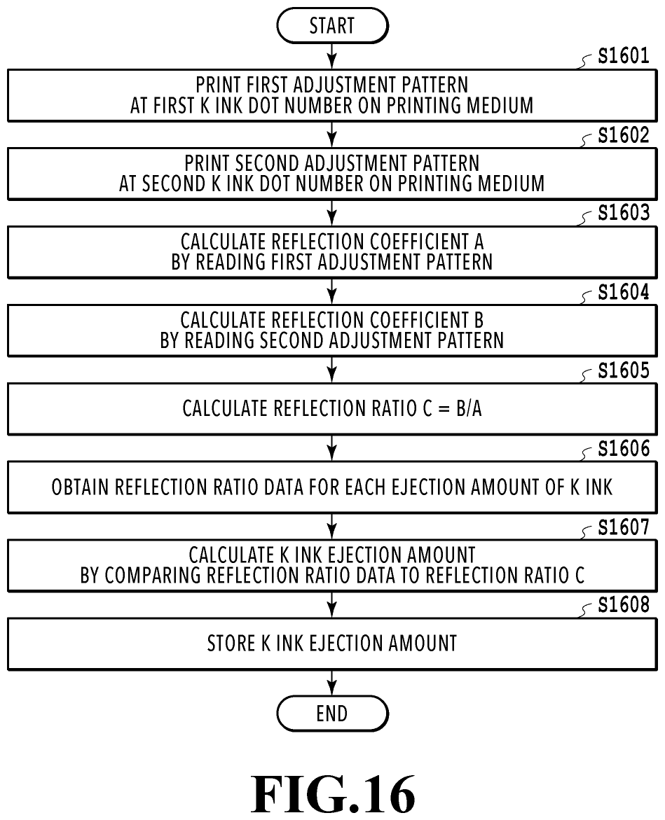

FIG. 16 is a flowchart of K ink ejection amount calculation processing according to the present embodiment. In a case where the user who wants to adjust a black density operates the printing apparatus 10 or the host apparatus 114, the K ink ejection amount calculation processing illustrated in FIG. 16 is started.

In S1601, the CPU 102 executes the printing processing to print the first adjustment pattern by using the K ink at the first K ink dot number on the printing medium.

In S1602, the CPU 102 executes the printing processing to print the second adjustment pattern by using the K ink at the second K ink dot number on the printing medium.

In S1603, the CPU 102 reads the first adjustment pattern by using the optical sensor 200 and calculates a reflection coefficient A based on a result of the reading.

In S1604, the CPU 102 reads the second adjustment pattern by using the optical sensor 200 and calculates a reflection coefficient B based on a result of the reading.

In S1605, the CPU 102 calculates a reflection ratio C(=B/A) based on the reflection coefficient A calculated in S1603 and the reflection coefficient B calculated in S1604.

In S1606, the CPU 102 obtains reflection ratio data for each ejection amount of the K ink from the storage region (the ROM 104 or the memory 108).

In S1607, the CPU 102 calculates the K ink ejection amount by comparing the reflection ratio data for each ejection amount of the K ink obtained in S1606 to the reflection ratio C calculated in S1605.

Finally, in S1608, the CPU 102 stores the K ink ejection amount calculated in S1607 in the storage region (the ROM 104 or the memory 108), and the series of processing ends.

As described above, in the present embodiment, the reflection ratio between the first K ink dot number and the second K ink dot number is stored in advance for each K ink ejection amount, and the stored reflection ratio is compared to the measured reflection ratio. With this, as with the W ink described in the first embodiment, it is possible to calculate the ink ejection amount of the K ink, which is the colored ink.

### Fourth Embodiment

In the third embodiment, a method of calculating the ink ejection amount of the colored ink by printing the adjustment pattern by using the colored ink on the printing medium is described. However, since the reflection ratio is changed depending on a type of the printing medium, it is complicated in terms of the necessity of obtaining and storing the reflection ratio for each printing medium in advance. In the present embodiment, in order to suppress such complicity, the ink ejection amount of the colored ink is calculated by using two adjustment patterns printed on the image of the W ink.

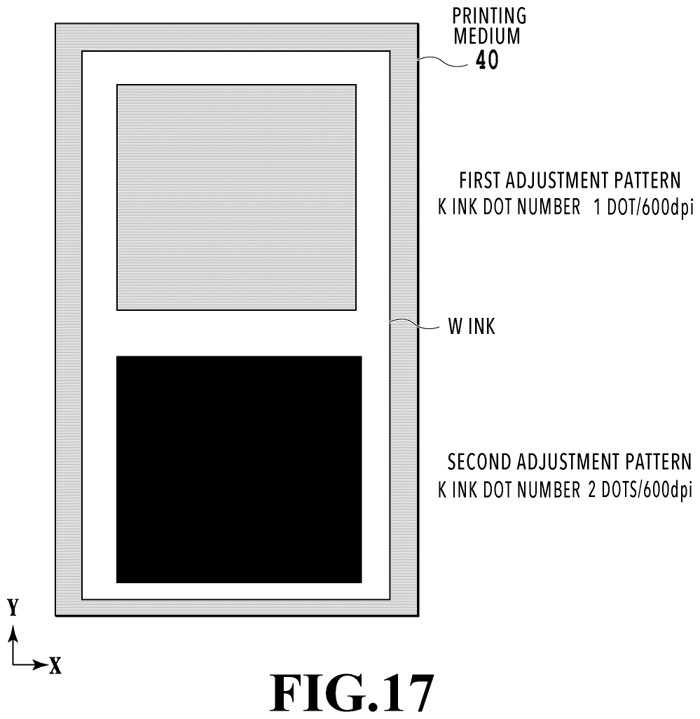

FIG. 17 is a diagram illustrating a K ink ejection amount calculation pattern according to the fourth embodiment. As illustrated in FIG. 17, an image as background is printed on the printing medium 40 by using the W ink, and two patterns, which are specifically a first adjustment pattern and a second adjustment pattern, are printed on the background next to each other in the Y direction (the conveyance direction). Since the background is printed by using the W ink before printing the adjustment patterns, there is a characteristic that the reflection coefficients with respect to the respective K ink amounts are the same among various printing media.

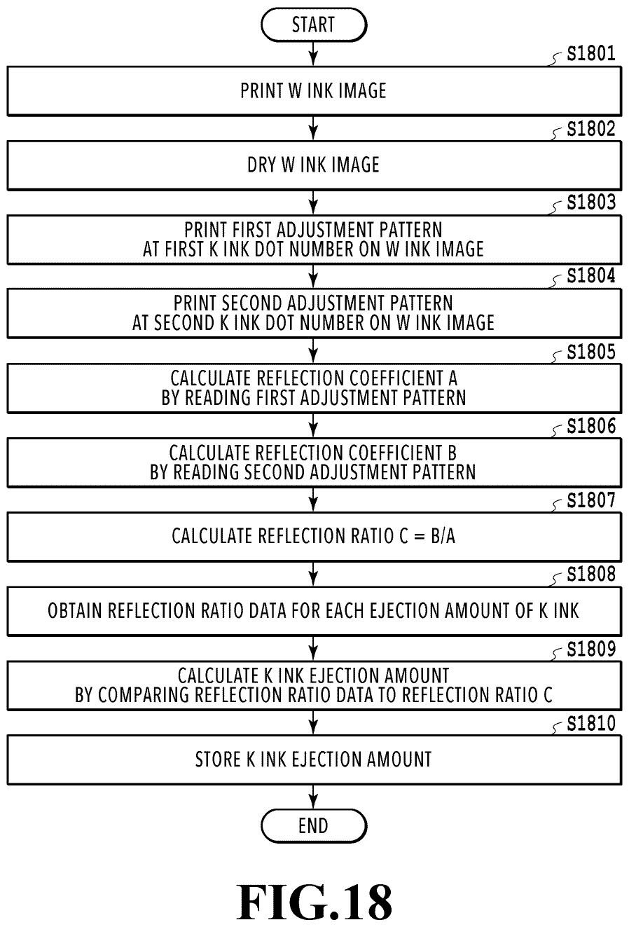

FIG. 18 is a flowchart of K ink ejection amount calculation processing according to the present embodiment.

The present embodiment is different from the third embodiment in that the W ink image as the background is printed and dried in S1801 and S1802. Note that, in S1803 and after that, although it is different in that the adjustment pattern is printed on the W ink image instead of on the printing medium, the other details are similar to that in the third embodiment (see FIG. 16).

As described above, according to the present embodiment, it is possible to calculate the ejection amount of the colored ink regardless of the type of the printing medium by using the two patch printed on the W ink.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to implement calibration at high accuracy without using a calibration plate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-000198, filed Jan. 4, 2024, which is hereby incorporated by reference wherein in its entirety.

What is claimed is:

1. A printing apparatus, comprising:
a printing head configured to eject a plurality of inks including a first ink from nozzles, the printing head ejecting the first ink to print a first adjustment pattern at a first ink dot number and print a second adjustment pattern at a second ink dot number;
a storage unit configured to store reflection ratio data that is a reflection ratio for each ejection amount of the first ink ejected from each of the nozzles;
a sensor configured to read an image printed on a printing medium;
a first acquisition unit configured to acquire a reflection ratio based on a first reflection coefficient obtained by reading the first adjustment pattern by the sensor and a second reflection coefficient obtained by reading the second adjustment pattern by the sensor; and
a second acquisition unit configured to acquire an ejection amount of the first ink in the nozzle based on the reflection ratio acquired by the first acquisition unit and the reflection ratio data.

2. The printing apparatus according to claim 1, wherein
a value of the first ink dot number and a value of the second ink dot number are different from each other.

3. The printing apparatus according to claim 1, wherein
a value of the first ink dot number and a value of the second ink dot number are set such that a value of the first reflection coefficient is greater than a value of the second reflection coefficient.

4. The printing apparatus according to claim 3, wherein
the value of the second ink dot number is smaller than the value of the first ink dot number.

5. The printing apparatus according to claim 1, wherein
light amount adjustment of the sensor is executed by using the first adjustment pattern printed on the printing medium.

6. The printing apparatus according to claim 1, wherein
the first acquisition unit acquires the reflection ratio by dividing the second reflection coefficient by the first reflection coefficient.

7. The printing apparatus according to claim 6, wherein
in a case where the reflection ratio acquired by the first acquisition unit matches any one of reflection ratios indicated by the reflection ratio data stored in the storage unit, the second acquisition unit acquires an ejection amount corresponding to the matching reflection ratio as the ejection amount of the first ink in the nozzle.

8. The printing apparatus according to claim 6, wherein
in a case where the reflection ratio acquired by the first acquisition unit matches no one of reflection ratios indicated by the reflection ratio data stored in the storage unit, the second acquisition unit acquires an ejection amount corresponding to one of the reflection ratios indicated by the reflection ratio data that is the closest to the reflection ratio acquired by the first acquisition unit as the ejection amount of the first ink in the nozzle.

9. The printing apparatus according to claim 6, wherein
in a case where the reflection ratio acquired by the first acquisition unit matches no one of reflection ratios indicated by the reflection ratio data stored in the storage unit and is smaller than a first reflection ratio indicated by the reflection ratio data and greater than a second reflection ratio indicated by the reflection ratio data, the second acquisition unit acquires the ejection amount of the first ink in the nozzle by interpolation acquisition using a first ejection amount corresponding to the first reflection ratio and a second ejection amount corresponding to the second reflection ratio.

10. The printing apparatus according to claim 1, wherein
the first ink is a white ink containing a white color material.

11. The printing apparatus according to claim 10, wherein
in the printing head, a second ink containing a colored color material is ejected.

12. The printing apparatus according to claim 11, wherein
after a background image is printed by ejecting the second ink by the printing head, the first ink is ejected on the background image, and the first adjustment pattern and the second adjustment pattern are printed.

13. The printing apparatus according to claim 10, wherein
the printing head prints the first adjustment pattern to an n-th adjustment pattern (n is an integer greater than 2) including the first adjustment pattern and the second adjustment pattern, and the n-th adjustment pattern is printed at an n-th ink dot number.

14. The printing apparatus according to claim 13, wherein
the first adjustment pattern to the n-th adjustment pattern are each arranged in different positions in a conveyance direction of the printing medium, and
in a case where a plurality of combinations of the first adjustment pattern to the n-th adjustment pattern are printed, the plurality of printed combinations are each arranged in different positions in a main scanning direction of the printing head.

15. The printing apparatus according to claim 14, wherein
based on a first reflection coefficient obtained by reading the first adjustment pattern and a second reflection coefficient obtained by reading each of adjustment patterns other than the first adjustment pattern, the first acquisition unit acquires a reflection ratio corresponding to each of the other adjustment patterns.

16. The printing apparatus according to claim 15, wherein
the second acquisition unit acquires an average value of ejection amounts corresponding to the other adjustment patterns as an ejection amount of the first ink.

17. The printing apparatus according to claim 12, wherein
the second ink is a black ink.

18. The printing apparatus according to claim 1, wherein
the first ink is a colored ink containing a colored color material.

19. The printing apparatus according to claim 18, wherein
in the printing head, a white ink containing a white color material is ejected as a second ink.

20. The printing apparatus according to claim 19, wherein
after a background image is printed by ejecting the second ink by the printing head, the first adjustment pattern and the second adjustment pattern are printed by ejecting the first ink on the background image.

21. The printing apparatus according to claim 20, further comprising:
a drying unit configured to dry an image printed on the printing medium by the printing head, wherein
after the background image is printed by the printing head, the background image is dried by the drying unit before the first adjustment pattern and the second adjustment pattern are printed.

22. The printing apparatus according to claim 1, wherein
a calibration plate is not included.

23. A method of controlling a printing apparatus, including
a printing head configured to eject a plurality of inks including a first ink from nozzles, the printing head ejecting the first ink to print a first adjustment pattern at a first ink dot number and print a second adjustment pattern at a second ink dot number,
a storage unit configured to store reflection ratio data that is a reflection ratio for each ejection amount of the first ink ejected from each of the nozzles, and
a sensor configured to read an image printed on a printing medium, the method comprising:
acquiring a reflection ratio based on a first reflection coefficient obtained by reading the first adjustment pattern by the sensor and a second reflection coefficient obtained by reading the second adjustment pattern by the sensor; and
acquiring an ejection amount of the first ink in the nozzle based on the reflection ratio acquired in the first acquisition and the reflection ratio data.

24. A non-transitory computer readable storage medium storing a program causing a computer to execute a method of controlling a printing apparatus, including
a printing head configured to eject a plurality of inks including a first ink from nozzles, the printing head ejecting the first ink to print a first adjustment pattern at a first ink dot number and print a second adjustment pattern at a second ink dot number,
a storage unit configured to store reflection ratio data that is a reflection ratio for each ejection amount of the first ink ejected from each of the nozzles, and
a sensor configured to read an image printed on a printing medium, the method comprising:
acquiring a reflection ratio based on a first reflection coefficient obtained by reading the first adjustment pattern by the sensor and a second reflection coefficient obtained by reading the second adjustment pattern by the sensor; and
acquiring an ejection amount of the first ink in the nozzle based on the reflection ratio acquired in the first acquisition and the reflection ratio data.
